(19) United States
(12) Patent Application Publication
(10) Pub. No.: US 2014/0006727 A1
(43) Pub. Date: Jan. 2, 2014

(54) CONTROL APPARATUS AND STORAGE APPARATUS

(71) Applicant: FUJITSU LIMITED, Kawasaki-Shi (JP)

(72) Inventors: Marie Abe, Kawasaki (JP); Koutarou Nimura, Kawasaki (JP); Yoshihito Konta, Kawasaki (JP)

(73) Assignee: Fujitsu Limited, Kawasaki-shi (JP)

(21) Appl. No.: 13/834,831

(22) Filed: Mar. 15, 2013

(30) Foreign Application Priority Data
Jun. 28, 2012 (JP) 2012-144969

(51) Int. Cl. G06F 3/06

(52) U.S. Cl. CPC G06F 3/0604
USPC 711/154

(57) ABSTRACT

A control apparatus includes a memory and a processor. The processor sets a comparison reference value on the basis of a first response time of a response to a first command that has been issued to a transmission destination. The processor stores the comparison reference value in the memory. The processor compares, when a second command is to be issued, a differential amount of data flows with the comparison reference value stored in the memory. The differential amount indicates a difference between an amount of data flows related to commands that have been issued to the transmission destination and an amount of data flows related to response data that have been received from the transmission destination. The processor restrains, when the differential amount exceeds the comparison reference value, the second command from being issued.

### CROSS-REFERENCE TO RELATED APPLICATION

This application is based upon and claims the benefit of priority of the prior Japanese Patent Application No. 2012-144969, filed on Jun. 28, 2012, the entire contents of which are incorporated herein by reference.

### FIELD

The embodiments discussed herein are related to a control apparatus and a storage apparatus.

### BACKGROUND

In a storage system such as a redundant array of inexpensive disks (RAID) system or the like, a disk apparatus such as a hard disk drive (HDD) is connected to an input/output (I/O) controller (IOC) of a controller module (CM). The IOC performs transferring of data between the disk apparatus and the CM. The IOC may be realized, for example, on a dedicated chip.

In a system according to a Serial Attached SCSI (SAS) standard, an apparatus at a transmission side is allowed to transmit a frame after permission for transmission called a credit is received from an apparatus at a reception side. The credit is a receiver ready (RRDY) message which is transmitted from the reception side to the transmission side to notify whether the reception side is in a state in which a buffer to receive a frame is usable.

The credit is used in transmission and reception between the IOC and the disk apparatus, and the credit is not detected by a central processing unit (CPU) or the like of the CM.

When the reception side is not capable of using the buffer and thus the reception side is not capable of receiving a frame, the reception side transmits a credit blocked message to notify the transmission side that the reception side is not capable of receiving a frame. When the transmission side receives the credit blocked message, the transmission side stops transferring data and waits for receiving a credit without transferring data.

For example, when data is read in the storage system, data is transferred while transmitting a credit for each frame to the disk apparatus at the transmission side from the IOC at the reception side.

For example, when an abrupt increase in amount of data flows occurs at one disk apparatus, a bus encounters an abrupt increase in data traffic load even if the disk apparatus does not yet reach a theoretical upper limit on hardware performance. As a result, at the beginning of reading data, buffer starvation may occur in the IOC at the reception side, and the IOC issues a credit blocked message to the disk apparatus.

In response to receiving the credit blocked message, the disk apparatus stops the data transfer operation. When a credit is issued thereafter, the data transfer is performed again.

Japanese National Publication of International Patent Application No. 2010-515156, Japanese Laid-open Patent Publication No. 2010-102458, and Japanese Laid-open Patent Publication No. 11-120091 disclose related techniques.

However, when the data transfer is performed again after the interruption due to the credit blocked message, the data is transferred not from a point at which the transmission was stopped but from the beginning of the data. Therefore, an occurrence of a credit blocked state results in an increase in data transfer time.

A process associated with the credit blocked state is a closed process performed only between the IOC and the disk apparatus as described above, and thus the CPU in the CM is only informed of an occurrence of a delay in a command transmission. That is, the CPU does not recognize the occurrence of the credit blocked state and thus the CPU may issue a command even in a state in which the credit blocked state occurs frequently. This may cause the CPU to wait for data transfer to be complete.

In a case where a credit blocked state occurs repeatedly a plurality of times, there is a possibility that data transfer is not complete within a predetermined timeout value, and a command timeout occurs. If a command timeout occurs, then, for example, a disk fault may occur as result of a statistical point-addition, which may cause the apparatus to stop. Recently, the SAS standard has been upgraded from version 1.0 to 2.0 and further to 3.0, which has brought about a great increase in data rate at which an interface handles data. As a result of the increase in the data rate of a transmission path, where there has been a bottle neck, the bottle neck at the bus is removed, and an improvement in throughput of the apparatus has been achieved. However, another bottle neck may occur at a location other than a transmission path.

Although a data transfer delay due to a credit blocked state is a problem hidden behind the bottle neck at the bus, the increase in bus performance, which has been recently achieved, has made the problem come to the surface.

### SUMMARY

According to an aspect of the present invention, provided is a control apparatus including a memory and a processor. The processor sets a comparison reference value on the basis of a first response time of a response to a first command that has been issued to a transmission destination. The processor stores the comparison reference value in the memory. The processor compares, when a second command is to be issued, a differential amount of data flows with the comparison reference value stored in the memory. The differential amount indicates a difference between an amount of data flows related to commands that have been issued to the transmission destination and an amount of data flows related to response data that have been received from the transmission destination. The processor restrains, when the differential amount exceeds the comparison reference value, the second command from being issued.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a CM disposed in a storage system according to an embodiment;

FIG. 2 is a diagram illustrating an example of a hardware configuration of a storage system according to an embodiment;

FIG. 3 is a diagram illustrating an example of reference information in a storage system according to an embodiment;

FIG. 4 is a diagram illustrating an example of a method of increasing reference information in a storage system according to an embodiment;

FIG. 5 is a diagram illustrating an example of a method of reducing reference information in a storage system according to an embodiment;

FIG. 6 is a flowchart illustrating an example of a process performed when a request command is issued by a CM in a storage system according to an embodiment;

FIG. 7 is a flowchart illustrating an example of a process performed when a response command is received by a CM in a storage system according to an embodiment; and

FIG. 8 is a flowchart illustrating an example of a process of resetting an average response time performed by a CM in a storage system according to an embodiment.

### DESCRIPTION OF EMBODIMENTS

A control apparatus, a storage apparatus, and a control method according to embodiments are described below with reference to drawings. Note that the embodiments are described below by way of example but not limitation. Many modifications to the embodiments are possible without departing from the spirit of the embodiment although they are not described. Also note that drawings are provided not to limit elements of embodiments to those illustrated in the drawings, but other elements or functions may be involved.

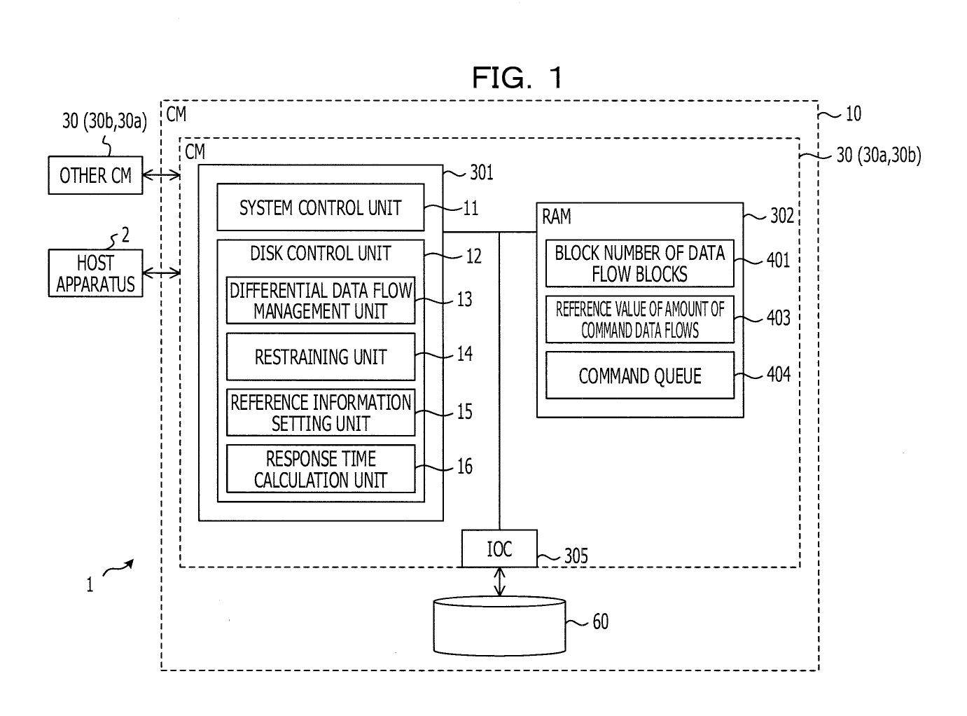

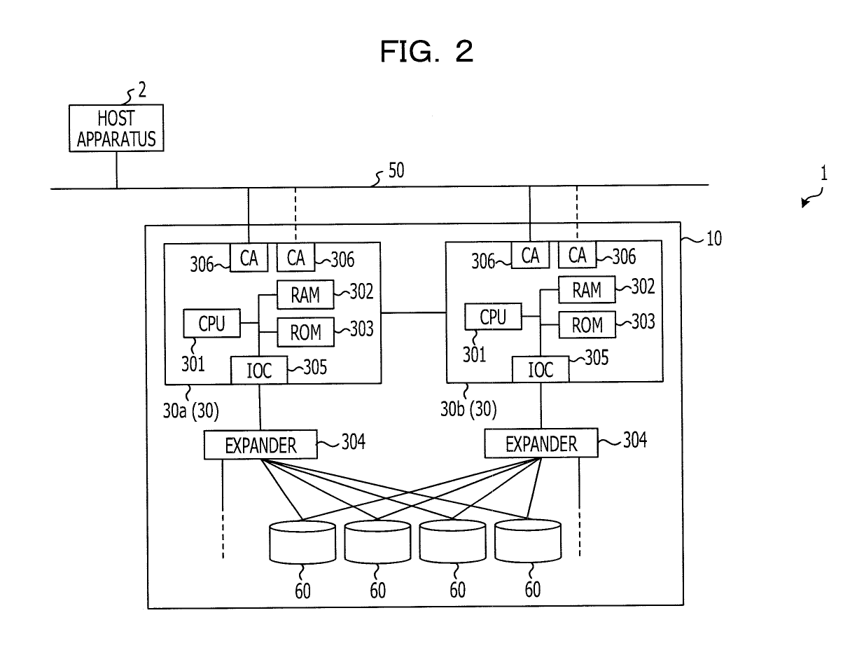

FIG. 1 is a diagram illustrating an example of a functional configuration of a CM disposed in a storage system 1 according to an embodiment, and FIG. 2 is a diagram illustrating an example of a hardware configuration thereof.

As illustrated in FIG. 2, the storage system 1 includes a storage apparatus 10 communicably connected to one or more host apparatuses 2 (one host apparatus 2 in the example illustrated in FIG. 1). In the storage system 1, the connection between the host apparatus 2 and the storage apparatus 10 may be performed, for example, using an Internet Small Computer System Interface (iSCSI) device.

The host apparatus 2 may be, for example, a computer (an information processing apparatus) having a server function. The host apparatus 2 is capable of transferring and receiving SCSI commands and various kinds of data such as a response, using a TCP/IP protocol or the like to or from the storage apparatus 10. The host apparatus 2 transmits a disk access command such as a read or write command to the storage apparatus 10 to read or write data in a storage area provided by the storage apparatus 10.

As illustrated in FIG. 2, the storage apparatus 10 includes controller modules (hereinafter referred to as CMs) 30a and 30b, expanders 304, and storage units 60.

The storage apparatus 10 is connected to the host apparatus 2 via a network 50 such as local area network (LAN) and also connected to a drive enclosure or the like (not illustrated in the drawing).

The expander 304 is, for example, a SAS expander configured to connect the HDDs 60 to the CMs 30a and 30b. The storage unit 60 is configured to store data in a readable and writable manner and functions as a storage unit capable of storing data received from the host apparatus 2. Note that in the present embodiment, it is assumed by way of example that an HDD is used as the storage unit 60. In the following description, the storage unit 60 may also be denoted as the HDD 60.

In FIG. 2, the storage apparatus 10 includes, by way of example, four HDDs 60. However, there is no particular restriction on the number of HDDs 60, i.e., the storage apparatus 10 may include three or less HDDs 60 or five or more HDDs 60. The storage apparatus 10 may be a RAID apparatus including a plurality of HDDs 60 which are combined such that the plurality of HDDs 60 function as a single storage with redundancy.

The expander 304 is an interface for communicably connecting to the HDDs 60, the drive enclosure (not illustrated), or the like, and the expander 304 includes a device adapter or the like. The CMs 30a and 30b write to or read from data the HDDs 60 via the expander 304.

The CMs 30a and 30b are controllers (control apparatuses) that control operations performed in the storage apparatus 10. The CMs 30a and 30b receive a command such as a read or write command from the host apparatus 2, and perform various kinds of control operations. Each of the CMs 30a and 30b is connected to a network via a CA 306. In response to receiving a command such as a read or write command from the host apparatus 2, the CMs 30a and 30b control the HDDs 60 via the respective expanders 304.

As illustrated in FIG. 2, each of the CMs 30a and 30b includes a plurality of CAs 306 (two CAs 306 in the example illustrated in FIG. 2) and further includes a CPU 301, a random access memory (RAM) 302, a read-only memory (ROM) 303, and an IOC 305, i.e., the CMs 30a and 30b are configured in a similar manner. The CM 30a and the CM 30b are connected to each other via a communication line. Thus, the CMs 30a and 30b form a redundant configuration.

Hereinafter, an expression CM 30 is used to denote an arbitrary one of CMs.

In FIG. 2, similar reference numerals denote similar or substantially similar elements, and a duplicated description thereof is omitted.

The CA 306 is an interface controller (communication adapter) to communicably connect to the host apparatus 2 or the like. The CA 306 receives data transmitted from the host apparatus 2 or the like, and transmits data output from the CM 30 to the host apparatus 2 or the like. That is, the CA 306 controls an operation of inputting or outputting data from or to an external apparatus such as the host apparatus 2.

The IOC 305 is configured to transfer data between the CM 30 and the HDD 60. The IOC 305 may be realized, for example, on a dedicated chip. The IOC 305 controls data flows to or from the HDD 60 using a credit and a credit blocked message.

More specifically, in an operation of receiving data (a frame) from the HDD 60, if a buffer is usable in receiving the frame, then the IOC 305 transmits a credit to the HDD 60 which is a sender of the frame. On the other hand, if the buffer is not usable in receiving the frame, the IOC 305 transmits a credit blocked message to the HDD 60.

In an operation of transmitting data to the HDD 60, when a credit is received from the HDD 60 which is a destination of a frame, the IOC 305 transmits the frame. On the other hand, when a credit blocked message is received from the HDD 60, the IOC 305 restrains the frame from being issued until a credit is received. Thereafter, if a credit is received from the HDD 60, IOC 305 retransmits data from the beginning of a first frame.

In response to an instruction from a disk control unit 12 (described later), the IOC 305 issues a command to the HDD 60 which is the destination.

The ROM 303 is a storage unit configured to store a program executed by the CPU 301 and various kinds of data. For example, a flash ROM may be used as the ROM 303.

The RAM 302 provides a storage area for storing various kinds of data or programs. When a CPU 301 executes a program, the CPU 301 stores the program and associated data in the RAM 302. The RAM 302 also functions as a buffer for storing data received from the host apparatus 2 or data read from the HDD 60. However, the RAM 302 may be configured in a different manner. For example, a memory may be disposed separately from the RAM 302 and the memory may be used as the buffer.

As illustrated in FIG. 1, the RAM 302 stores data indicating a block number 401 of data flow blocks, a reference value (reference information, comparison reference value) 403 of the amount of command data flows and a command queue 404.

The command queue 404 is a queue in which a command to be issued by the disk control unit 12 to the HDD 60 is registered by a restraining unit 14 which is described later.

The disk control unit (command issuance instruction unit) 12 (described later) instructs the IOC 305 to issue commands registered in the command queue 404 to the destination HDD 60 in the same order as the commands were registered, i.e., in a first-in first-out (FIFO) manner.

The block number 401 of data flow blocks and the reference value 403 of the amount of command data flows will be described in detail later.

The CPU 301 is a processing apparatus that performs various control operations and calculations. The CPU 301 executes programs stored in the ROM 303 or the RAM 302 thereby achieving various functions.

More specifically, for example, the CPU 301 executes programs to realize functions as the system control unit 11, i.e., to achieve a RAID configuration and various functions including an alarm monitoring function, a path controlling function, a reliability, availability, and serviceability (RAS) function, etc.

The alarm monitoring function monitors an occurrence of an alarm from the HDD 60 or devices in the system to detect an error or a failure in the system. The path controlling function controls a path via which a command or the like is transferred. For example, when a failure or an error is detected in a network path, a path is determined so as to detour around a location where the failure or the error occurs, and data is transferred along the determined path. The RAS function is a function that makes it possible to achieve high reliability, availability, and maintainability. For example, the RAS function includes handling degeneration of a cache memory, error-correcting code (ECC), detecting errors, or the like.

Note that the functions of the system control unit 11 are not limited to those described above, but the system control unit 11 may have other functions as the CM.

Furthermore, as illustrated in FIG. 1, the CPU 301 achieves functions as the disk control unit 12 by executing a program.

The disk control unit 12 controls operations such as accessing the HDD 60. More specifically, for example, the disk control unit 12 controls accessing the HDD 60 in response to host I/O from the host apparatus 2.

The disk control unit 12 has a function (a command processing function) of processing a command transmitted to or received from the HDD 60. The disk control unit 12 issues various commands (request commands), such as a read command, a write command, etc., to the HDD 60.

When the disk control unit 12 transmits a request command to the HDD 60, the disk control unit 12 measures a time elapsed from the transmission of the request command to the transmission of a response command in response to the request command from the HDD 60. The disk control unit 12 compares the elapsed time with a predetermined reference timeout value (for example, 5 seconds). In a case where the time elapsed since the transmission of the request command exceeds the reference timeout value, the disk control unit 12 determines that a timeout error has occurred. When a timeout error has occurred, the disk control unit 12 notifies an operator or the like of the occurrence of the timeout error, or the disk control unit 12 retransmits the request command.

In the present embodiment, a reference reset period, which is an interval at which response times and an average response time are reset as will be described later, is determined based on the reference timeout value described above. For example, the reference reset period (for example, 0.5 seconds) may be set to be one tenth of the reference timeout value. As illustrated in FIG. 1, the disk control unit 12 has functions as a differential data flow management unit 13, a restraining unit 14, a response time calculation unit 16, and a reference information setting unit 15.

The differential data flow management unit 13 manages a differential amount of data flows which is the difference between an amount of issuance data flows related to commands that have been issued by the CM 30 to associated one or more HDDs 60 (destination) and an amount of response data flows related to response data (commands) from the associated one or more HDDs 60 to the CM 30.

In the present embodiment, the differential data flow management unit 13 manages the amount of issuance data flows and the amount of response data flows on the basis of a number (block number) of blocks (one block includes 512 bytes) included in each command data. The differential data flow management unit 13 determines the differential amount of data flows that is the difference between the block number of issuance data and the block number of response data, and the differential data flow management unit 13 stores the determined differential amount of data flows as the block number 401 of data flow blocks in the RAM 302.

More specifically, when the disk control unit 12 transmits a request command to the HDD 60, the differential data flow management unit 13 adds the block number of blocks included in data (request command data) related to the request command to the value of the block number 401 of data flow blocks. On the other hand, when the disk control unit 12 receives a response command from the HDD 60, the differential data flow management unit 13 subtracts the block number of blocks included in data (response command data) related to the response command from the value of the block number 401 of data flow blocks. Thus, the value of the block number 401 of data flow blocks represents the current differential amount of data flows in real time. Hereinafter, the differential amount of data flows will also be denoted as the differential amount of command data flows.

In a case where request commands are issued to the respective ones of the HDDs 60 connected to the CM 30, the differential data flow management unit 13 adds a block number of blocks related to the request command issued to each HDD 60 to the block number 401 of data flow blocks. In a case where response commands are received from the respective ones of the HDDs 60 connected to the CM 30, the differential data flow management unit 13 subtracts a block number of blocks related to the request command received from each HDD 60 from the block number 401 of data flow blocks.

The amount of command data flows of commands that have been issued is acquired when the CM 30 issues the command to the HDD 60. The differential data flow management unit 13 also acquires the amount of response data flows when response data is received from the HDD 60. Various techniques are known for the acquisition of the amount of issuance data flows and the amount of response data flows, thus a further description thereof is omitted here.

For example, in a case where the CM 30 issues read requests to four HDDs 60 to read data of 5, 10, 15, and 10 Mbyte, respectively, the amount of issuance data flows=5+10+15+10=40 Mbyte (81,920 blocks). If the four HDDs 60 respectively transmit data of 5, 10, 15, 10 Mbyte as response data to the read requests, the amount of response data flows=5+10+15+10=40 Mbyte (81,920 blocks).

In a case where at least one or more HDDs 60 are not capable of transmitting a response data in response to the read request because of an overloaded state or for other reasons, a difference (differential amount of data flows) occurs between the amount of issuance data flows and the amount of response data flows at that point of time. The block number 401 of data flow blocks indicates the differential amount of data flows.

The restraining unit 14 restrains a command from being issued to the HDD 60. More specifically, in the operation of issuing the command, the restraining unit 14 puts (registers) the request command to be issued in the command queue 404 thereby restraining the request command from being immediately transferred to the IOC 305.

The restraining unit 14 compares the value of the block number 401 of data flow blocks calculated by the differential data flow management unit 13 with the reference value (reference information, comparison reference value) 403 of the amount of command data flows stored in the RAM 302. In a case where the differential amount of data flows is equal to or smaller than the reference value 403 of the amount of command data flows, i.e., when there is a room to increase the amount of issuance command data flows, the command is issued to the destination HDD 60 via the IOC 305. On the other hand, when the differential amount of data flows is greater than the reference value 403 of the amount of command data flows, the restraining unit 14 puts the command to be issued in the command queue 404.

When the disk control unit 12 determines that it is allowed to issue a command, commands put in the command queue 404 are issued via the IOC 305 to the HDD 60 one by one in the same order as the commands were registered.

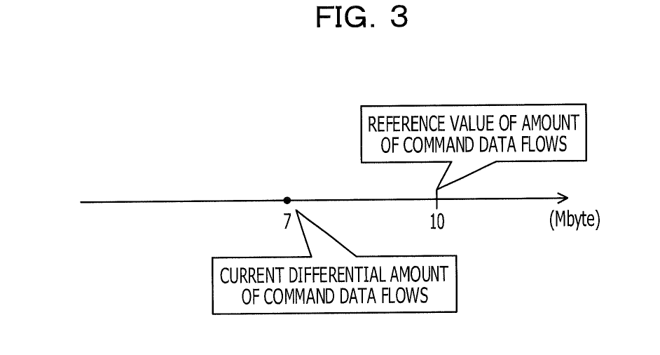

FIG. 3 is a diagram illustrating an example of the reference value 403 of the amount of command data flows in the storage system 1 according to the present embodiment.

In the example illustrated in FIG. 3, the reference value 403 of the amount of command data flows is 10 Mbyte (20,480 blocks), and the current value of the differential amount of data flows (differential amount of command data flows) is 7 Mbyte (14,336 blocks). The current value (7 Mbyte) of the differential amount of data flows is smaller than or equal to the reference value 403 of the amount of command data flows, and thus the restraining unit 14 does not store the command in the command queue 404 and allows the disk control unit 12 to issue the command to the destination HDD 60 via the IOC 305.

In a case where an average response time calculated by the response time calculation unit 16 described later is equal to or smaller than the reference timeout value, it is regarded that there is a room to issue a command. Also in this case, the restraining unit 14 does not restrain the command from being issued to the HDD 60, i.e., the restraining unit 14 does not put the command in the command queue 404, but the restraining unit 14 allows the disk control unit 12 to issue the command to the destination HDD 60 via the IOC 305.

The response time calculation unit 16 calculates an average value of response times of responses to the commands issued to the destination HDD 60. When a response command is received from the HDD 60, the response time calculation unit 16 acquires an elapsed time (response time) since the issuance command corresponding to the response command was issued. The response time calculation unit 16 stores the acquired response time in a particular storage area of the RAM 302.

The response time calculation unit 16 then calculates the average value (average response time) of response times of the current response command and the previously received response commands stored in the RAM 302. The response time calculation unit 16 stores the calculated average response time in a particular storage area of the RAM 302.

The response times and the average response time stored in the RAM 302 are reset every preset reference reset period (for example, every 0.5 second). Thus, the response time calculation unit 16 calculates the average value of response times acquired in a period up to the reference reset period (for example, 0.5 seconds) after the previous calculation of the average response time.

It may be meaningless to maintain an old value of the average response time, and a value based on the latest reference value 403 of the amount of command data flows may be preferably employed. However, in the storage system 1, the reference information setting unit 15 dynamically changes the reference value 403 of the amount of command data flows as will be described in detail later. Therefore, if the average response time is reset each time the reference value 403 of the amount of command data flows is changed, a reduction occurs in the population parameter of the response times that are subjected to the calculation of the average response time. This may cause the average response time to have an untypical value.

Therefore, in the storage system 1, the disk control unit 12 performs a timer interruption every reference reset period to reset the average response time. By periodically resetting the average response time, it becomes possible to typically obtain the latest average response time, which allows an increase in reliability of the apparatus.

The reference reset period may be set, for example, to be one tenth of the reference timeout value (for example, 5 seconds).

The reference information setting unit 15 sets the reference value 403 of the amount of command data flows on the basis of the average response time calculated by the response time calculation unit 16 and the value of the differential amount of command data flows at that point of time calculated by the differential data flow management unit 13.

The reference information setting unit (reference range setting unit) 15 sets the reference value 403 of the amount of command data flows on the basis of the response time for a command issued to the HDD 60.

However, the reference information setting unit 15 changes the reference value 403 of the amount of command data flows only when the amount of response command data flows from the HDD 60 is equal to or greater than a particular value (for example, 4 Kbytes=8 blocks). When the amount of response command data flows is smaller than the particular value, the reference value 403 of the amount of command data flows is not changed.

When a response command has an amount of data less than the particular value, the probability is low that the command is blocked, and the probability is also low that an influence occurs on other commands. Therefore, in this case, the reference value 403 of the amount of command data flows is not changed. That is, only commands having the possibility of encountering a command blocking are taken into account in the process of changing the reference value 403 of the amount of command data flows, which leads to a reduction in influenced range.

The amount of response command data flows may be measured in data size instead of the block number of blocks included in the response command data, or may be measured in other units.

A lower limit is defined on the reference value 403 of the amount of command data flows such that the reference value 403 of the amount of command data flows is not set to be smaller than this lower limit. The lower limit may be defined based on a test result or the like such that commands are empirically processed with a sufficiently large margin. For example, the lower limit may be set to 5 Mbyte.

Increasing Reference Value of Amount of Command Data Flows

The reference information setting unit 15 increases the reference value 403 of the amount of command data flows when the average response time is equal to or smaller than a predetermined reference response time (a predetermined reference value) and the differential amount of command data flows is greater than the reference value 403 of the amount of command data flows.

Note that the reference response time is smaller than the timeout value described above. More specifically, for example, the reference response time may be set to be a value obtained by multiplying a factor M (M<1) to the timeout value. In the present embodiment, the reference response time is set, by way of example, to be a value obtained by multiplying 0.9 (M=0.9) to the timeout value, and more specifically the reference response time is set to 4.5 (seconds).

When the average response time is equal to or less than the predetermined reference response time, it is regarded that it is allowed to issue a command with a sufficiently large margin. Thus, the reference information setting unit 15 increases the reference value 403 of the amount of command data flows to allow a greater amount of command data to be issued, i.e., to increase an allowable amount of issuance data flows.

In a case where the value of the differential amount (current differential amount) of command data flows at that point of time calculated by the differential data flow management unit 13 is greater than the reference value 403 of the amount of command data flows, the reference value 403 of the amount of command data flows is replaced with the value of the current differential amount of command data flows.

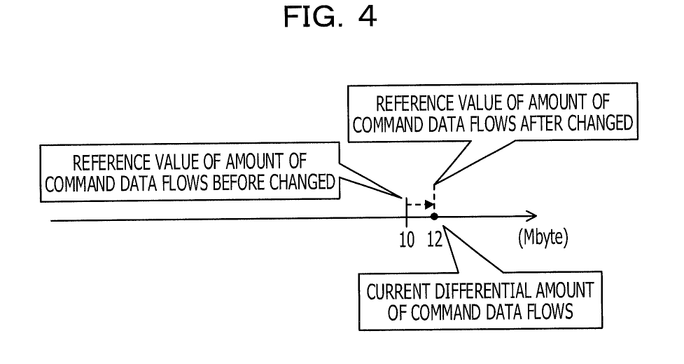

FIG. 4 illustrates a method of increasing the reference value 403 of the amount of command data flows in the storage system 1 according to the present embodiment.

In the example illustrated in FIG. 4, the average response time is less than or equal to the predetermined reference response time and furthermore the differential amount (12 Mbyte) of command data flows is greater than the reference value 403 (10 Mbyte) of the amount of command data flows. That is, the reference value 403 of the amount of command data flows before changed is 10 Mbyte.

In this case, the reference information setting unit 15 replaces the reference value 403 of the amount of command data flows with the current differential amount of command data flows. As a result, the reference value 403 of the amount of command data flows is changed to 12 Mbyte.

Reducing Reference Value of Amount of Command Data Flows

When the average response time is greater than the predetermined reference response time and the differential amount of command data flows is equal to or less than the reference value 403 of the amount of command data flows, the reference information setting unit 15 reduces the reference value 403 of the amount of command data flows.

If the average response time is greater than the predetermined reference response time, this means that the margin is decreasing in issuing commands, and thus there is a high possibility that the reference timeout value is going to be reached and a timeout error will occur.

Thus the reference information setting unit 15 reduces the reference value 403 of the amount of command data flows to reduce the amount of command data issued, i.e., the amount of data issued.

More specifically, the reference value 403 of the amount of command data flows is replaced with a value obtained by multiplying a factor k (k<1) to the current value of the differential amount of command data flows at that point of time calculated by the differential data flow management unit 13.

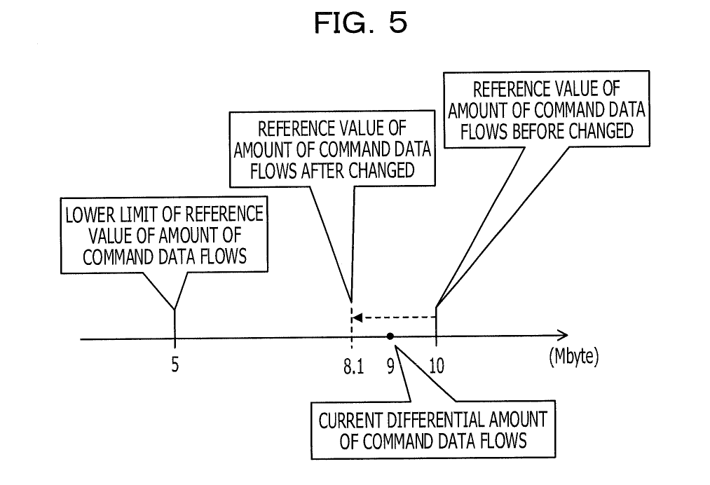

FIG. 5 illustrates an example of a method of reducing the reference value 403 of the amount of command data flows in the storage system 1 according to the present embodiment.

In the example illustrated in FIG. 5, the average response time is greater than the predetermined reference timeout value and the differential amount (9 Mbyte) of command data flows is less than the reference value 403 (10 Mbyte) of the amount of command data flows. That is, the reference value 403 of the amount of command data flows before changed is 10 Mbyte.

In this case, the reference information setting unit 15 calculates a value that is a product of the current differential amount of command data flows and a factor k (when k=0.9, the value is 8.1). The reference information setting unit 15 then replaces the reference value 403 of the amount of command data flows with the value (8.1) calculated based on this current differential amount of command data flows. Thus, the reference value 403 of the amount of command data flows is changed to 8.1 Mbyte.

Note that the reference information setting unit 15 sets the reference value 403 of the amount of command data flows such that the reference value 403 of the amount of command data flows is not less than the lower limit. This is because, as described above, the reference value 403 of the amount of command data flows is set to a value (for example, 5 Mbyte) determined based on a test result or the like such that the value empirically allows a sufficient margin in processing the command.

Also in a case where the average response time is greater than the predetermined reference value of response time and the differential amount of command data flows is greater than the reference value 403 of the amount of command data flows, the reference information setting unit 15 may preferably reduce the reference value 403 of the amount of command data flows thereby reducing the amount of command data issued, i.e., the amount of data issued.

For example, when a value obtained by multiplying the factor k (k<1) to the differential amount of command data flows at that point of time calculated by the differential data flow management unit 13 is smaller than the reference value 403 of the amount of command data flows, then the reference information setting unit 15 replaces the reference value 403 of the amount of command data flows with this resultant value of the product.

When the average response time is less than or equal to the predetermined reference value of response time and the differential amount of command data flows is less than or equal to the reference value 403 of the amount of command data flows, the reference value 403 of the amount of command data flows may be replaced with a value obtained by multiplying the factor k to a predetermined upper limit of the reference value 403 of the amount of command data flows, or the reference value 403 of the amount of command data flows may be maintained without being changed.

In a case where the differential amount of command data flows is less than or equal to the reference value 403 of the amount of command data flows, the reference information setting unit 15 sets the reference value 403 of the amount of command data flows to be equal to the lower limit.

A program (a control program) to realize each function described above may be stored in a computer-readable recording medium and provided. Examples of computer-readable recording media include a flexible disk, a compact disc (CD) including CD-ROM, CD-R, CD-RW, etc., a digital versatile disc (DVD) including DVD-ROM, DVD-RAM, DVD-R, DVD+R, DVD-RW, DVD+RW, HD, DVD etc., a Blu-ray disk, a magnetic disk, an optical disk, a magneto-optical disc, etc. A computer may read the program from the recording medium and may transfer the program into an internal storage device or an external storage device to execute the program. Alternatively, the program may be stored in a storage device (or a recording medium) such as a magnetic disk, an optical disk, or a magneto-optical disc, and may be provided from the storage device to the computer via a communication line.

To realize functions as the system control unit 11 and the disk control unit 12 (the differential data flow management unit 13, the restraining unit 14, the response time calculation unit 16, and the reference information setting unit 15), the control program stored in the internal storage device (the RAM 302 or the ROM 303 in the CM 30 in the present embodiment) is executed by a microprocessor (the CPU 301 in the present embodiment) of the computer. In this operation, the program stored in the recording medium may be read and executed by the computer.

In the present embodiment, the computer may include hardware and an operating system, and the hardware may operate under the control of the operating system. In a case where the hardware operates only with an application program without using the operating system, the hardware functions as the computer. The hardware includes a microprocessor such as a CPU and a unit capable of reading a computer program stored on a recording medium. In the present embodiment, the CM 30 has a function as the computer.

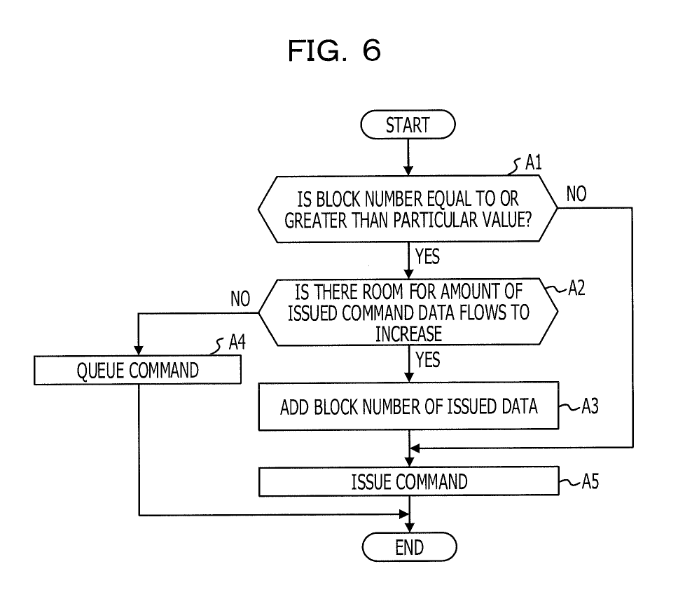

Referring to a flowchart illustrated in FIG. 6, a description is given below as to a process performed by the CM 30 in the storage system 1 when a request command is issued according to an embodiment. In the following description, by way of example, the process is performed when the CM 30 issues a read request to the HDD 60.

The differential data flow management unit 13 checks the amount of data (request command data) related to a read request command to be transmitted to the HDD 60. The amount of request command data may be measured, for example, in a block number of blocks included in the request command data.

The differential data flow management unit 13 then checks whether the block number of blocks included in the request command data is equal to or greater than a particular value (for example, 4 Kbytes=8 blocks) (A1).

If the amount of request command data is equal to or greater than the particular value, the request command data is subjected to a data flow control performed in A2 to A4 described below.

On the other hand, when the amount of the request command data is less than the particular value, the possibility is low that command blocking occurs, and the possibility is also low that an influence occurs on other commands, and thus the request command data is not subjected to the data flow control. That is, the data flow control is performed only for commands having a possibility of encountering command blocking.

An influence on the amount of data flows occurs when a sequential I/O operation handling data of a large data size is performed. Therefore, in the sequential I/O operation, commands may be restrained from being issued. More specifically, the amount of data flows is counted only for commands with data of a size equal to or greater than a particular value, and commands with data of a size less than the particular value are not subjected to the data flow control.

On the other hand, in a random I/O operation, a size of data per command is small and has a small influence in an abrupt increase in the amount of data flows. Therefore, the commands are not subjected to the data flow control. That is, the commands may be issued without being queued. Note that this may be applied to the sequential I/O operation handling data of a small data size.

As a result, there is a possibility that a random I/O operation gets ahead of a sequential I/O operation. However, a correct order of commands may be ensured by the RAID control, and thus getting ahead of a command does not result in a problem in the process.

In a case where the block number of blocks of request command data issued to the HDD 60 is equal to or greater than 8 (YES in A1), the restraining unit 14 compares the differential amount of command data flows calculated by the differential data flow management unit 13 with the reference value 403 of the amount of command data flows. That is, the restraining unit 14 checks whether there is a room for the amount of issuance command data flows to increase by determining whether the differential amount of command data flows is equal to or smaller than the reference value 403 of the amount of command data flows (A2).

In a case where there is a room for the amount of issuance command data flows to increase, i.e., in a case where the differential amount of command data flows is equal to or smaller than the reference value 403 of the amount of command data flows (YES in A2), the disk control unit 12 adds the block number of blocks related to the request command checked in A1 to the value of the block number 401 of data flow blocks stored in the RAM 302 (A3).

The disk control unit 12 transfers this request command to the IOC 305, and the request command is issued from the IOC 305 to the destination HDD 60. (A5). Thus the process is ended.

On the other hand, in a case where there is no room for the amount of issuance command data flows to increase, i.e., the differential amount of command data flows is greater than the reference value 403 of the amount of command data flows (NO in A2), the restraining unit 14 puts (command queuing) the request command in the command queue 404 (A4). Then the process is ended. By putting the request command in the command queue 404, the request command is inhibited from immediately transferred to the IOC 305.

In a case where the block number of blocks included in a request command data to be issued to the HDD 60 is equal to or smaller than 7 (NO in A1), the data flow control from A2 to A4 is not performed, but, in A5, the request command is issued to the destination HDD 60 via the IOC 305.

As described above, when the amount of data related to the request command is smaller than a particular value, the probability is low that command blocking occurs, and the probability is also low that an influence occurs on other commands, and thus the request command is not subjected to the data flow control.

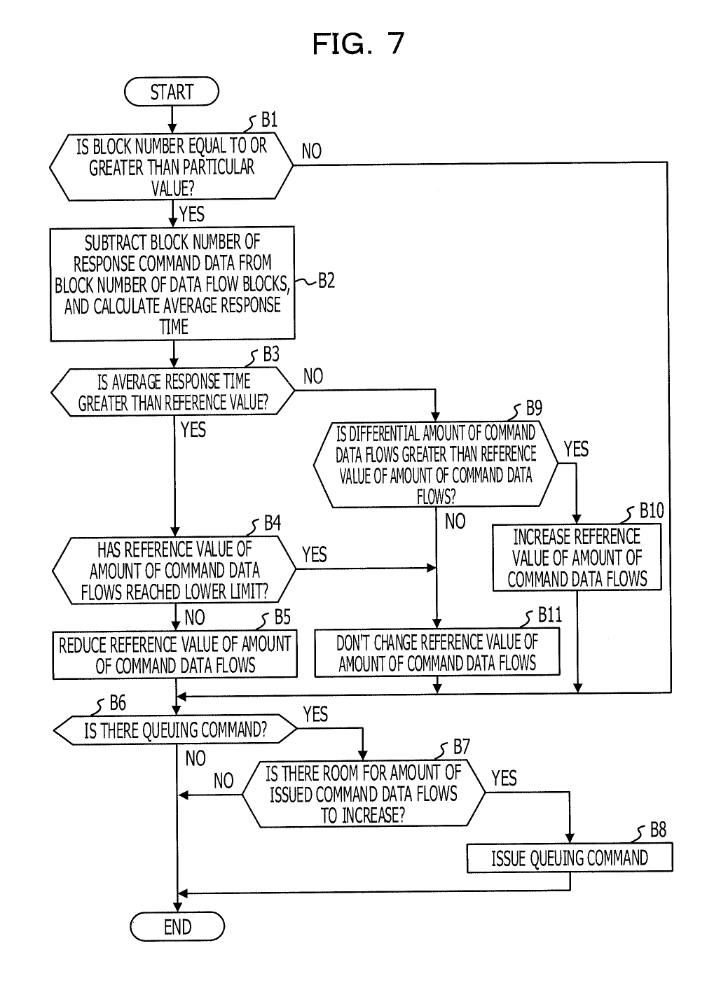

Next, referring to a flowchart illustrated in FIG. 7, a description is given as to a process performed by the CM 30 in the storage system 1 when a response command is received. In an example described below, a response command is received in response to a read request issued from the CM 10 to the HDD 60.

The differential data flow management unit 13 checks the amount of data (response command data) related to a read response command to be received from the HDD 60. The amount of response command data may be measured, for example, in a block number of blocks included in the response command data.

The differential data flow management unit 13 checks whether the block number of blocks included in f the response command data is equal to or greater than a particular value (for example, 4 Kbytes=8 blocks) (B1).

In a case where the amount of response command data is equal to or greater than the particular value, the response command data is subjected to a process of changing the reference value 403 of the amount of command data flows performed in B2 to B5, B9, and B10.

When the amount of the response command data is smaller than the particular value, the probability is low that command blocking occurs, and the probability is also low that an influence occurs on other commands. Therefore, in this case, the response command data is not subjected to the process of changing the reference value 403 of the amount of command data flows. That is, only commands having a possibility of encountering command blocking are taken into account in the process of changing the reference value 403 of the amount of command data flows, which leads to a reduction in influenced range.

In a case where the block number of blocks of the response command data is equal to or greater than 8 (YES in B1), the differential data flow management unit 13 changes the block number 401 of data flow blocks by subtracting the block number of blocks of the response command data (response data) from the block number 401 of data flow blocks. The response time calculation unit 16 then calculates the average value (average response time) of response times of the current response command and the previously received response commands stored in the RAM 302 (B2).

The reference information setting unit 15 compares the calculated average response time with the predetermined reference response time to check whether the average response time is greater than the reference response time (B3). In a case where the average response time is greater than the reference response time (YES in B3), the reference information setting unit 15 checks whether the reference value 403 of the amount of command data flows has reached its lower limit (B4). That is, the reference information setting unit 15 checks whether there is a room to further reduce the reference value 403 of the amount of command data flows.

In a case where the reference value 403 of the amount of command data flows has not yet reached the lower limit (NO in B4), the reference information setting unit 15 reduces the reference value 403 of the amount of command data flows (B5).

In this process in B5, the reference information setting unit 15 compares the current differential amount of command data flows, i.e., the block number 401 of data flow blocks, with the reference value 403 of the amount of command data flows.

In a case where the block number 401 of data flow blocks is equal to or smaller than the reference value 403 of the amount of command data flows, the reference information setting unit 15 calculates a value that is a product of the current differential amount of command data flows and a factor k (when k=0.9, the value is 8.1). The reference information setting unit 15 then reduces the reference value 403 of the amount of command data flows by replacing the reference value 403 of the amount of command data flows with the value (8.1) calculated based on the current differential amount of command data flows.

Also in a case where the block number 401 of data flow blocks is greater than the reference value 403 of the amount of command data flows and the value obtained by multiplying the factor k to the current differential amount of command data flows is smaller than the reference value 403 of the amount of command data flows, the reference information setting unit 15 replaces the reference value 403 of the amount of command data flows with the value calculated based on the current differential amount of command data flows.

In a case where the value obtained by multiplying the factor k to the current differential amount of command data flows is equal to or greater than the reference value 403 of the amount of command data flows, the reference value 403 of the amount of command data flows may be replaced with a value obtained by multiplying the factor k to the upper limit of the reference value 403 of the amount of command data flows, or the reference value 403 of the amount of command data flows may be remained without being changed.

In a case where the block number 401 of data flow blocks is smaller than the reference value 403 of the amount of command data flows, the reference value 403 of the amount of command data flows is set to be equal to the lower limit of the reference value 403 of the amount of command data flows. That is, the reference value 403 of the amount of command data flows is reduced down to its lower limit.

Thereafter, the disk control unit 12 checks whether there is a request command (queuing command) registered in the command queue 404 (B6). In a case where there is no queuing command (NO in B6), the process is ended.

In a case where there is a queuing command (YES in B6), then, the disk control unit 12 checks whether the differential amount of command data flows is equal to or smaller than the reference value 403 of the amount of command data flows. That is, a determination is performed as to whether there is a room to increase the amount of issuance command data flows (B7).

In a case where the differential amount of command data flows is equal to or smaller than the reference value 403 of the amount of command data flows, i.e., there is a room to increase the amount of issuance command data flows (YES in B7), the disk control unit 12 transfer a request command located at the top of the command queue 404 to the IOC 305. That is, the disk control unit 12 issues the queuing command to the destination HDD 60 (B8), and ends the process.

In a case where the differential amount of command data flows is greater than the reference value 403 of the amount of command data flows, i.e., there is no room to increase the amount of issuance command data flows (NO in B7), it is determined that there is no room to transfer the request command, and the process is ended without performing a further process.

In a case where the block number of blocks of the response command data is equal to or smaller than 7 (NO in B1), B2 to B5 are skipped and the process proceeds to B6 without changing the reference value 403 of the amount of command data flows by the reference information setting unit 15. When the amount of data related to the response command is smaller than the particular value, the probability is low that command blocking occurs, and the probability is also low that an influence occurs on other commands, and thus the reference information setting unit 15 does not take this request command into account in the process of changing the reference value 403 of the amount of command data flows.

In a case where the average response time is equal to or smaller than the reference response time (NO in B3), the reference information setting unit 15 compares the current differential amount of command data flows, i.e., the block number 401 of data flow blocks, with the reference value 403 of the amount of command data flows (B9).

In a case where the block number 401 of data flow blocks is greater than the reference value 403 of the amount of command data flows (YES in B9), the reference information setting unit 15 replaces the reference value 403 of the amount of command data flows with the current differential amount of command data flows thereby increasing the reference value 403 of the amount of command data flows (B10). Thereafter, the process proceeds to B6.

In a case where the block number 401 of data flow blocks is equal to or smaller than the reference value 403 of the amount of command data flows (NO in B9), the reference information setting unit 15 advances the process to B6 without changing the reference value 403 of the amount of command data flows (B11). However, when the differential amount of command data flows is smaller than the lower limit of the reference value 403 of the amount of command data flows, the upper limit is changed to be equal to the lower limit.

Also in a case where the reference value 403 of the amount of command data flows has reached the lower limit (YES in B4), the reference information setting unit 15 does not change the reference value 403 of the amount of command data flows (B11) and advances the process to B6.

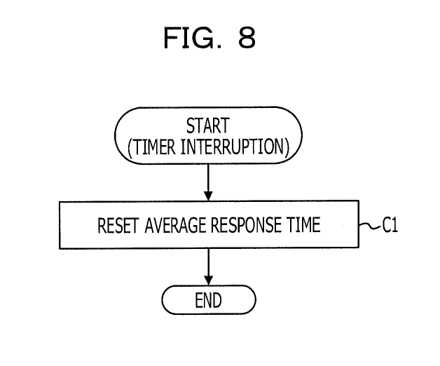

Next, referring to a flowchart illustrated in FIG. 8, a description is given as to a method of resetting the average response time by the CM 30 in the storage system 1 according to an embodiment.

A reset instruction signal is input to the response time calculation unit 16 in response to a timer interruption that occurs every reference reset period (for example, every 0.5 seconds) (C1). Upon receiving the reset instruction signal, the response time calculation unit 16 deletes (resets) the response times and the average response time stored in the RAM 302. As a result, old response times and an old average response time do not remain in the RAM 302, and the response time calculation unit 16 calculates an average value of response times acquired in the reference reset period (for example, 0.5 seconds). That is, the response time calculation unit 16 is capable of calculating the average value of response times in a latest state of the storage system 1.

As described above, in the storage system 1 according to the present embodiment, when the disk control unit 12 issues a request command, if the differential amount of data flows is greater than the reference value 403 of the amount of command data flows, the restraining unit 14 registers the request command in the command queue 404. This causes the request command to be restrained from being transferred to the IOC 305, and thus data related to the request command is not stored in the buffer by the IOC 305. That is, the cache of the IOC 305 is inhibited from being full, and thus a credit blocked state is inhibited from occurring.

As a result, an improvement is achieved in terms of efficiency of transferring commands and data between the CM 30 and HDD 60. Furthermore, by inhibiting a command timeout from occurring, it becomes possible to inhibit a disk fault or a CM panic caused by the command timeout from occurring.

In a case where the block number (the data size) of blocks of the request command data to be issued to the HDD 60 is equal to or smaller than a particular value, the restraining unit 14 does not restrain this request command from being issued, but the restraining unit 14 allows the request command to be issued to the destination HDD 60 via the IOC 305. That is, when the amount of data of the request command is equal to or smaller than the particular value, the request command is not taken into account in the data flow control. This results in an increase in command processing speed, and a reduction in processing load on the CPU 301.

When a response command is received, the reference information setting unit 15 updates the reference value 403 of the amount of command data flows on the basis of the current differential amount of data flows. That is, the reference value 403 of the amount of command data flows is set to an optimum value depending on a transferring state of the system. For example, in a case where the average response time is not greater than the reference response time, it is determined that there is a more room for the capacity to process a greater amount of data, and thus the reference value 403 of the amount of command data flows is increased. This makes it possible to issue a greater number of request commands, i.e., an increase in processing speed is achieved.

The reference information setting unit 15 increases the reference value 403 of the amount of command data flows by replacing the reference value 403 of the amount of command data flows with the differential amount of data flows at that point of time. That is, a new value of the reference value 403 of the amount of command data flows is given by the differential amount of data flows in the state in which the average response time is not greater than the reference response time, i.e., in the state in which the data transfer performance is guaranteed. Thus, the reference value 403 of the amount of command data flows is increased while maintaining the data transfer performance, and an improvement in reliability is achieved.

To reduce the reference value 403 of the amount of command data flows, the reference information setting unit 15 may replace the reference value 403 of the amount of command data flows with a value obtained by multiplying a factor k (k<1) to the differential amount of data flows at that point of time. This makes it possible to reduce the reference value 403 of the amount of command data flows by a proper amount depending on the differential amount of data flows at that point of time, which results in an increase in reliability.

The details of techniques are not limited to those described above, but many modifications are possible without departing from the spirit and scope of the embodiments.

For example, although in the embodiments described above, the amount of command data flows of a request command or a response command is handled in units of blocks, the amount of command data flows may be handled in other units. More specifically, for example, the amount of command data flows may be measured in data size instead of the block number of blocks included in a command.

In the embodiments, the system includes two CMs 30a and 30b and two expanders 304. Alternatively, the system may include one CM 30 and one expander 304, or the system may include three or more CMs 30 and three or more expanders 304.

Note that the storage unit 60 is not limited to the HDD, but other types of storage units such as a solid state drive (SSD) may be employed.

The configurations and the processes described in the embodiments may be properly selected and combined.

The description given above may allow those skilled in the art to practice the embodiments and produce the apparatuses according to the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus comprising:
a memory; and
a processor to
set a comparison reference value on the basis of a first response time of a response to a first command that has been issued to a transmission destination,
store the comparison reference value in the memory,
compare, when a second command is to be issued, a differential amount of data flows with the comparison reference value stored in the memory, the differential amount indicating a difference between an amount of data flows related to commands that have been issued to the transmission destination and an amount of data flows related to response data that have been received from the transmission destination, and
restrain, when the differential amount exceeds the comparison reference value, the second command from being issued.

2. The control apparatus according to claim 1, wherein
the processor increases the comparison reference value when the first response time is equal to or less than a predetermined reference response time and when the differential amount exceeds the comparison reference value.

3. The control apparatus according to claim 2, wherein
the processor replaces the comparison reference value with the differential amount when the first response time is equal to or less than the predetermined reference response time and when the differential amount exceeds the comparison reference value.

4. The control apparatus according to claim 1, wherein
the processor reduces the comparison reference value when the first response time is equal to or greater than a predetermined reference response time.

5. The control apparatus according to claim 4, wherein
the processor replaces the comparison reference value with a value smaller than the differential amount when the first response time is equal to or greater than the predetermined reference response time.

6. The control apparatus according to claim 1, wherein
the processor changes the comparison reference value when an amount of response command data flows from the transmission destination is equal to or greater than a particular value.

7. The control apparatus according to claim 1, wherein
the processor restrains, when the differential amount exceeds the comparison reference value, the second command from being issued by storing the second command in a command queue.

8. The control apparatus according to claim 1, wherein
the processor
calculates an average value of response times of responses to commands that have been issued to the transmission destination, and
sets the comparison reference value on the basis of the calculated average value.

9. The control apparatus according to claim 8, wherein
the processor calculates the average value of response times of responses received in a predetermined period before the calculation.

10. A storage apparatus comprising:
a storage unit; and
a processor to
set a comparison reference value on the basis of a first response time of a response to a first command that has been issued to the storage unit,
compare, when a second command is to be issued, a differential amount of data flows with the comparison reference value, the differential amount indicating a difference between an amount of data flows related to commands that have been issued to the storage unit and an amount of data flows related to response data that have been received from the storage unit, and
restrain, when the differential amount exceeds the comparison reference value, the second command from being issued.

11. The storage apparatus according to claim 10, wherein
the processor increases the comparison reference value when the first response time is equal to or less than a predetermined reference response time and when the differential amount exceeds the comparison reference value.

12. The storage apparatus according to claim 11, wherein
the processor replaces the comparison reference value with the differential amount when the first response time is equal to or less than the predetermined reference response time and when the differential amount exceeds the comparison reference value.

13. The storage apparatus according to claim 10, wherein
the processor reduces the comparison reference value when the first response time is equal to or greater than a predetermined reference response time.

14. The storage apparatus according to claim 13, wherein
the processor replaces the comparison reference value with a value smaller than the differential amount when the first response time is equal to or greater than the predetermined reference response time.

15. The storage apparatus according to claim 10, wherein
the processor changes the comparison reference value when an amount of response command data flows from the storage unit is equal to or greater than a particular value.

16. The storage apparatus according to claim 10, wherein
the processor restrains, when the differential amount exceeds the comparison reference value, the second command from being issued by storing the second command in a command queue.

17. The storage apparatus according to claim 10, wherein
the processor
calculates an average value of response times of responses to commands that have been issued to the storage unit, and
sets the comparison reference value on the basis of the calculated average value.

18. The storage apparatus according to claim 17, wherein
the processor calculates the average value of response times of responses received in a predetermined period before the calculation.

19. A computer-readable recording medium storing a program that causes a computer to execute a procedure, the procedure comprising:
setting a comparison reference value on the basis of a first response time of a response to a first command that has been issued to a transmission destination;
comparing, when a second command is to be issued, a differential amount of data flows with the comparison reference value, the differential amount indicating a difference between an amount of data flows related to commands that have been issued to the transmission destination and an amount of data flows related to response data that have been received from the transmission destination; and
restraining, when the differential amount exceeds the comparison reference value, the second command from being issued.

20. The computer-readable recording medium according to claim 19, the procedure further comprising:
increasing the comparison reference value when the first response time is equal to or less than a predetermined reference response time and when the differential amount exceeds the comparison reference value.
